(19) United States
(12) Patent Application Publication
(10) Pub. No.: US 2021/0323258 A1
(43) Pub. Date: Oct. 21, 2021

(54) Can Crushing and Bagging Device

(71) Applicant: Allen Winterer, Hemet, CA (US)

(72) Inventor: Allen Winterer, Hemet, CA (US)

(21) Appl. No.: 17/103,714

(22) Filed: Nov. 24, 2020

Related U.S. Application Data
(60) Provisional application No. 63/101,176, filed on Apr. 21, 2020.

(51) Int. Cl. B30B 9/32; B30B 1/04; B30B 15/32; B09B 5/00

(52) U.S. Cl. CPC B30B 9/321; B09B 5/00; B30B 15/32; B30B 1/04

(57) ABSTRACT

An aluminum can crushing device is provided to encourage recycling of drink and other cans. The can crushing device employing a handle engaged with a housing, provides significant mechanical advantage to a user during the crushing process. A tilting base automatically ejects crushed cans from an internal cavity into a removably engaged bag.

### FIELD OF THE INVENTION

This application claims priority to U.S. Provisional Patent Application Ser. No. 63/101,176, filed on Apr. 21, 2020 which included herein in its entirety, by this reference thereto.

The present device relates to aluminum cans. More particularly, the disclosed device relates to a portable hand-operated aluminum can crushing apparatus which automatically ejects crushed cans to chute communicating the crushed can to a breathable collection bag, without the need for the user to touch the can subsequent to compacting.

### BACKGROUND OF THE INVENTION

Worldwide, the manufacture and sale of beverages in cans has become the predominant manner in which soft drinks and other beverages are manufactured and sold to customers. However, customers for such beverages must either collect the empty cans in receptacles for recycling, which can become large and unwieldy, or simply throw them in the trash. The disposing of such aluminum cans in the trash is ecologically unsound due to the ease which aluminum, if collected, can be recycled.

Numerous can collection devices have been manufactured and sold in recent years. To aid in collection storage and recycling of aluminum drink cans, can crushers have also been manufactured and sold to consumers for the purposes of compacting empty cans so they may be stored and recycled.

The forgoing background concerning conventional can crushing devices and limitations related therewith are intended to be illustrative and not exclusive, and they do not imply any limitations on the invention described and claimed herein. Various other limitations of the related art are known or will become apparent to those skilled in the art upon a reading and understanding of the specification below and the accompanying drawings.

### SUMMARY OF THE INVENTION

The portable hand-operated can crushing device and system herein disclosed is structured to provide functions not found in the conventional can crushing devices in prior art and achieves the above noted objects through the provision of portable hand-operated can crushing device, which automatically ejects crushed cans to a breathable bag. Thereafter the compacted collected cans within the bag can be taken to a recycling center for recycling in an ecologically positive manner.

The device herein features a can crusher having a cavity in which an empty can is positioned, which will accommodate a large variety of empty beverage can sizes. The device features a primary handle which generates mechanical advantage in a rotating engagement with members which translate a compacting member positioned on an upper end of a cavity. The cavity is accessible for insertion of a can with the handle elevated. However, once the compression action is initiated by a user, the cavity is surrounded by a housing sidewall and a cover, thereby protecting the user from accidentally positioning portions of their hand in a position which could cause injury.

Once the can has been compressed within the cavity surrounded by the housing and cavity cover, the can may be ejected into a chute, by a slight lifting of the handle in a direction away from a base within the cavity on which the crushed can is positioned. A lifting connector, engaged between a compacting member and the base, causes the base to pivot on a rotating connection to the housing of the device. This slants the base in a manner to cause the compacted can, to slide through a second opening and into a chute, without the need for the user to touch the compacted can with their hand.

A bag operatively engaged to a portion of the device surrounding the chute in which cans are ejected collects the compacted cans within an interior chamber of the bag. The bag is formed preferably of breathable fabric. Once the bag is removed and the cans held therein deposited to a larger container, the bag may be rinsed and reused, thereby eliminating the waste of collecting crushed beverages in plastic bags which are disposed.

With respect to the above description, before explaining at least one preferred embodiment of the herein disclosed hand-operated can crushing invention in detail, it is to be understood that the invention is not limited in its application to the details of construction and to the arrangement of the components in the following description or illustrated in the drawings. The can crushing device herein described and shown is capable of other embodiments and of being practiced and carried out in various ways which will become obvious to those skilled in the art upon reading this disclosure. Also, it is to be understood that the phraseology and terminology employed herein are for the purpose of description and should not be regarded as limiting.

As such, those skilled in the art will appreciate that the conception upon which this disclosure is based may readily be utilized as a basis for designing of other hand-operated automatic ejecting can crushing structures, methods and systems for carrying out the several purposes of the present disclosed device. It is important, therefore, that the claims be regarded as including such equivalent construction and methodology insofar as they do not depart from the spirit and scope of the present invention.

As used in the claims to describe the various inventive aspects and embodiments, “comprising” means including, but not limited to, whatever follows the word “comprising”. Thus, use of the term “comprising” indicates that the listed elements are required or mandatory, but that other elements are optional and may or may not be present. By “consisting of” is meant including, and limited to, whatever follows the phrase “consisting of”. Thus, the phrase “consisting of” indicates that the listed elements are required or mandatory, and that no other elements may be present. By “consisting essentially of” is meant including any elements listed after the phrase, and limited to other elements that do not interfere with or contribute to the activity or action specified in the disclosure for the listed elements. Thus, the phrase “consisting essentially of” indicates that the listed elements are required or mandatory, but that other elements are optional and may or may not be present depending upon whether or not they affect the activity or action of the listed elements. The term “substantially”, unless otherwise specifically defined, means plus or minus five percent.

It is an object of the present invention to provide a lightweight and easily mounted aluminum can crushing device to encourage use and the ecological recycling of multiple sized aluminum cans, by a large portion of households.

It is an additional object of this invention to provide such a can crushing device which requires no electric power to operate.

It is yet another object of the invention herein, to provide a can crushing device which automatically ejects crushed cans to a breathable and reusable bag subsequent to compacting, thereby eliminating the need for users to touch the crushed can with their hands.

It is a further object of this invention, to provide a can crushing device, which surrounds a cavity in which the can is compacted, with a housing to thereby form a shield to prevent pinching of fingers of the user and other potential injuries which may occur during the crushing cycle.

An additional object of this invention is the provision of such a can crushing device, which automatically ejects a crushed can into a breathable mesh duffel or bag, to eliminate the need for the user to touch the crushed can which may be dirty and/or have potential sharp projections thereon which could injure the user.

These and other objects, features, and advantages of the present can crushing invention, as well as the advantages thereof over existing prior art, which will become apparent from the description to follow, are accomplished by the improvements described in this specification and hereinafter described in the following detailed description which fully discloses the invention, but should not be considered as placing limitations thereon.

### BRIEF DESCRIPTION OF DRAWING FIGURES

The accompanying drawings, which are incorporated herein and form a part of the specification, illustrate some, but not the only or exclusive examples of embodiments and/or features of the disclosed hand-operated automatic ejecting can crushing device. It is intended that the embodiments and figures disclosed herein are to be considered illustrative of the invention herein, rather than limiting in any fashion.

In the drawings:

FIG. 1 depicts the can crushing device herein, showing it in a first or elevated position, having the handle which is pivotally engaged to a housing, in a first or elevated position, which concurrently lifts a connecting member and an engaged to a compacting member, and uncovers a first opening communicating with an internal cavity.

FIG. 2 shows the device of FIG. 1, showing the handle lowering toward a second or lowered position during the crushing or compressing of a can inserted into the internal cavity with the device in the first or elevated position of FIG. 1.

FIG. 3 displays the device of FIGS. 1-2 in a second position wherein a can inserted into the interior cavity has been crushed or compacted between the compacting member and a base which is fixed in position at a lower end of the internal cavity.

FIG. 4 shows the device as in FIG. 3, with the housing removed to better show the handle in the second or fully lowered position thereby locating the compacting member at its closest point to the base, and showing a particularly preferred magnetic lifting connector which is operatively engaged to tilt the pivotally engaged base and thereby eject the crushed can into a chute which is positioned adjacent a second opening in the housing communicating with the internal cavity.

FIG. 5 depicts pivotally engaged base, moved to a tilted position by the motion of a magnet moving in a direction away from the base, which is actuated by movement of the handle from the lowered position toward the raised position after compacting or crushing of the can has occurred as shown in FIG. 3, to thereby cause the crushed can to slide and eject through the second opening in the housing, and into the chute adjacent the second opening.

FIG. 6 shows the device where the handle has been raised subsequent to reaching the second or lowered position of FIG. 3, which will actuate the lifting connector to tilt the base and eject the can, as in FIGS. 4-5, through a chute and into a breathable duffel or bag removably engaged to a shelf surrounding the chute.

### DETAILED DESCRIPTION OF THE INVENTION

In this description, the directional prepositions of up, upwardly, down, downwardly, front, back, top, upper, bottom, lower, left, right, first, second, and other such terms refer to the device as it is oriented and appears in the drawings and all such terms are used for convenience only and such are not intended to be limiting or to imply that the device has to be used or positioned in any particular orientation.

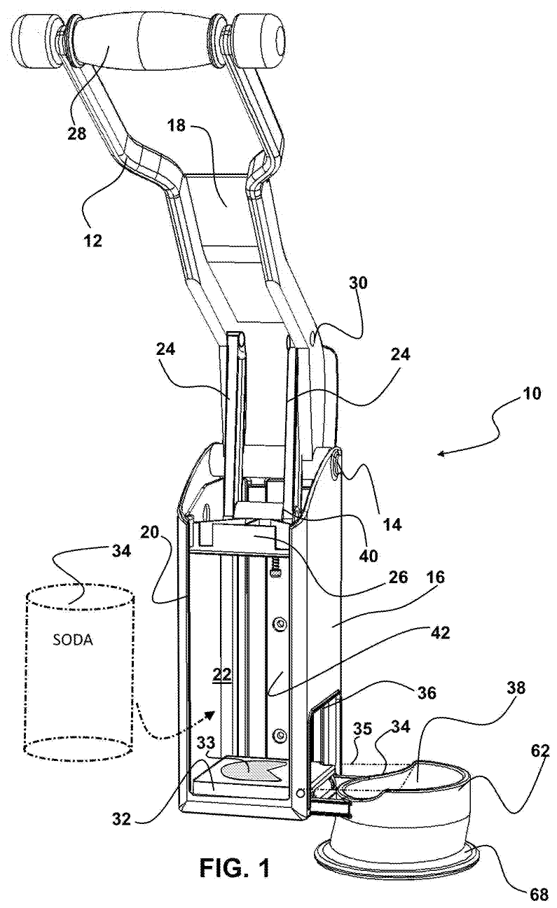

Now referring to drawings in FIGS. 1-6, wherein similar components are identified by like reference numerals, there is seen in FIG. 1 the can crushing device 10 herein, showing it in a first position. In this first position, the handle 12 which is a pivoting engagement 14 to a frame or support or housing 16, when raised lifts a housing cover 18 to fully expose a first opening 20 in the housing 16. This first opening 20 communicates with and provides access to insert a can into, an internal cavity 22.

A first end of a connecting member 24 is in a rotational engagement 30 to the handle 12, adjacent a second end of the handle 12, which is opposite a grip 28 end of the handle 12. By rotational engagement is meant that a connection between the connecting member 24 and the handle 12 allows that connection to rotate as the handle 12 moves up and down, and that connection causes translation of the connecting member 24 as the handle 12 moves up and down.

A length of a portion of the handle 12 between the grip 28, and the rotational engagement 30 of the handle 12 to the connecting member 24, in combination with the fixed pivoting engagement 12 of the handle 12 to the housing 16, provides for significant mechanical advantage in operation of the device 10.

This mechanical advantage allows the user to easily force the compacting member 24 toward the base 32 of the internal cavity 22 which is located at an opposite end of the internal cavity 22 from the compacting member 26 when the handle is raised to the first position of FIG. 1. Continued travel by the compacting member 26 caused by continued lowering of the handle 12 toward the base 32, will thereby crush or compact a can 34, inserted into the internal cavity 22 through the first opening 20. As described herein, the can 34 once crushed or compacted is ejected through a second opening 36 formed in the housing 16 and then into a chute 38.

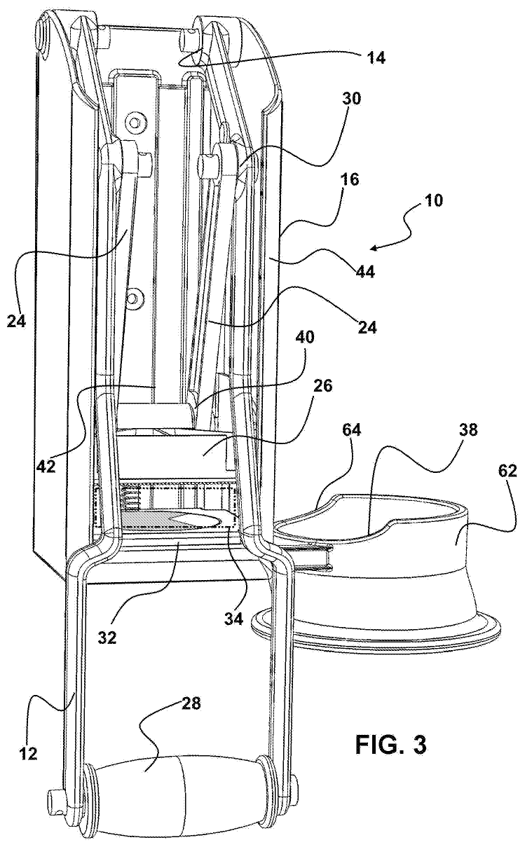

Also shown in FIG. 1, and other figures below, the second end of the connecting member 24, is in a pivoting engagement 40 with the compacting member 26. During travel of the compacting member 26 within the internal cavity 22, toward the base 32, the internal surfaces of the housing 18 form a track the compacting member 26 travels. As can be discerned, a can 34 positioned within the internal cavity 22 during this travel of the compacting member 26, will be in a sandwiched position between the base 32 and the compacting member 26, and subjected to the force generated by the mechanical advantage noted above. The can 34 will thus be transformed to a crushed or compact configuration as shown in FIGS. 3 and 5.

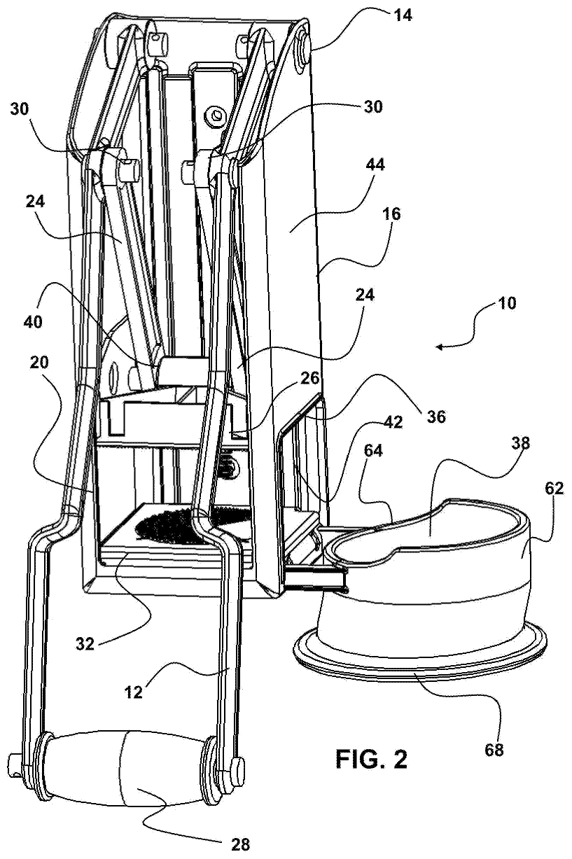

Shown in FIG. 2, the is the device of FIG. 1, wherein the handle 12 has been lowered by force exerted upon the grip 28, which has moved the handle toward the second or lowered position shown in FIG. 3 but not fully lowered. As can be seen, the volume of the internal cavity 22 in between the compacting member 26 and the base 32, has been reduced. Thus, the volume of the internal cavity 22 will continually be reduced, and any can 34, positioned therein, will be continuously collapsed until the handle 12 has reached the second or lowered position of FIG. 3, wherein the internal cavity 22 has the least volume and the closest positioning between the compacting member 26 and the base 32.

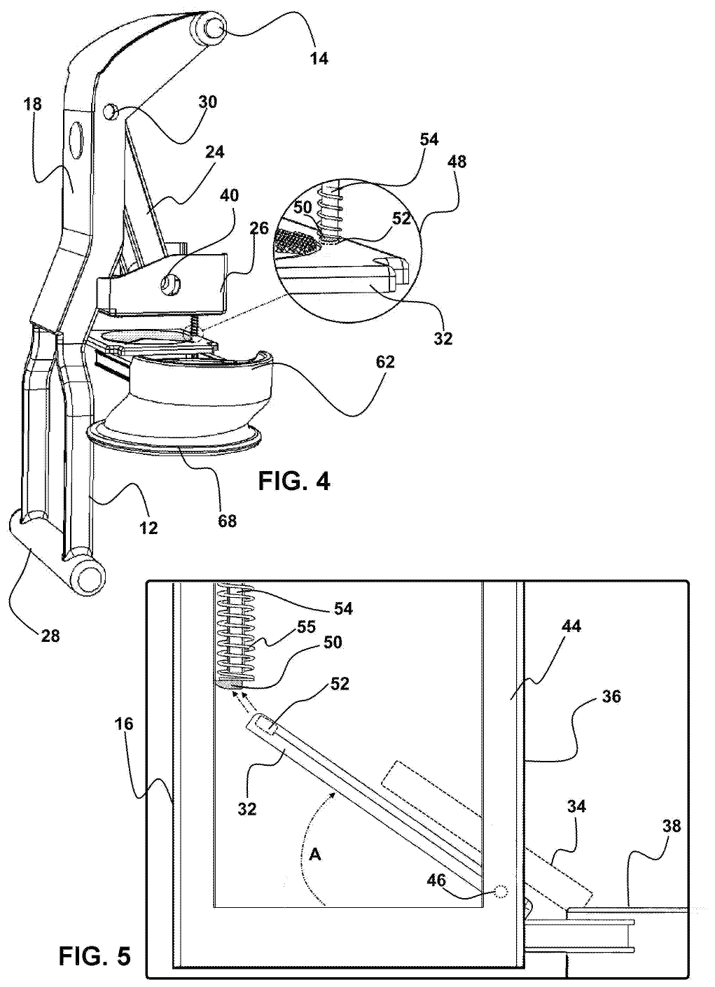

During this crushing or compacting of a can 34, the can 34 positioned within the internal cavity 22 will be surrounded by the sidewall 44 of the housing 16 on three sides, and by housing cover 18 shown in FIG. 1, but removed from other figures for ease of viewing the components. This surrounded positioning of the can 34 within the internal cavity 22, serves to protect the user from any flying debris or liquids that might occur during the compressive forces on the can 34. Further, the housing cover 18 and the sidewall 44, form a shield which prevents the user or a bystander, from positioning any portion of their hand within the internal cavity 22 during use. This shield formed by the housing cover 18, is best seen in FIG. 4, which shows the handle 12 in the second or lowered position with the housing removed for clarity. However one skilled in the art can discern that the cover 18 in this position will cover and form a shield between the first opening 20 and the user lowering the handle 12, as the user lowers the handle 12 for the length of travel from the raised or first position of FIG. 1, to the fully lowered position of FIG. 4. So positioned, the cover 18 forms a shield between the user and the opening 20, to prevent insertion of their hand or fingers, and, and to prevent debris such as any liquids or detaching metal from a can 34 being crushed in the cavity 22, which might exit the opening 20, as it reduces in volume and crushes the can, from striking the user.

As noted, in FIG. 3 is shown the device 10, with the handle 12 moved to the second position, wherein it has forced under mechanical advantage, the compacting member 26 to a closest position relative to the base 32. The volume of the internal cavity 22 has thus been reduced to the smallest amount, and a can 34 positioned in between the compacting member 26 and the base 32 has been crushed to a fraction of its original length and size. It is at this stage of the crushing cycle, that the device 10 operates to continue to keep and prevent the user from touching the crushed can 34.

The device 10 herein, in all modes, preferably has a base 32 which is in a rotating connection 46 (FIG. 5) with the housing 16 at a first side thereof which is positioned adjacent the second opening 36. By at a first side is meant between the edge of the first side and the center of the base 32 which is located in between the first side and second side of the base 32. By adjacent is meant the first side of the base 32 is inside or within an inch of said second opening.

A lifting connector 48 which is operatively engaged to the compacting member 24 or to the handle 12, is actuated to move toward and away from the base 32, by movement of the handle 12 between the elevated position of the handle and lowered position of the handle 12. Movement of the handle 12 from the elevated position toward the lowered position thereof, will move the projecting member 54 of the lifting connector 48, in a first movement and in a first direction, from a first position, raised and out of magnetic and/or physical contact with the base 32, toward the base 32.

Once movement in this first direction places the projecting member 54 of the lifting connector 48 in a second position where it is in contact with the base 32, or in position connectively proximate thereto, it will form a removable engagement with the base 32. By connectively proximate is meant that the connector such as a magnet upon the projecting member 54 forming part of the lifting connector 48, is positioned close enough to the base 32, that a temporary magnetic connection is formed, or in the case of releasable fastener such as hook and loop fabric, the hook and loop fabric located on the projecting member 54 and the base 32, are positioned close enough to form a contact between hook and loop fabric, operatively positioned on the base 32 and the projecting member 54 of the lift connector 48.

The lifting connector 48, while in the second position where the projecting member 54 is lowered and the removable engagement is formed with the base 32, (such as in FIG. 4) can be actuated to move toward the first position (such as in FIG. 1) or raised positioning, by movement of the handle 12, toward the elevated position of FIG. 1. This movement toward the first position of projecting member 54 of the lifting connector 48, will cause the base 32 to move to the tilted positioning as in FIG. 5, until the removable engagement detaches.

In the case of a magnetic attraction the removable engagement will detach once the magnet 50 on the projecting member 54 of the lifting connector 48 moves far enough from the magnetically attractive material 52 on the base 32. In the case of a mechanical lifting connector 48, such as hook and loop fabric, the removable engagement will detach once the projecting member 54 of the lifting connector 48 moves a sufficient distance in the second direction, to cause detachment between hook and loop fabric located on the end of the lifting connector 48 and on the base 32.

As noted, this lifting connector 48 when in such a removable engagement, operates to rotate the base 32 on the rotating connection 46, and thereby to raise a second side of the base 32, opposite the first side having the rotating connection 46 and thereby move the base to the tilted position as in FIG. 5. The base 32 is thus lifted by the removable engagement of the lifting connector 48 and movement of the projecting member 54, to a tilted position at an angle A, which will cause the compressed can 34, to slide off the base 32, and through the second opening 36, and into the chute 38. As noted, the operation to move the lifting connector 48 from the second position back to the first position thereof, is caused by a movement of the handle 12 back toward the first or elevated position of FIG. 1, from the second or lowered position shown in FIG. 3-4, which moves the projecting member 54 in the same direction.

This lifting connector 48 (FIG. 4), forms a self-releasing engagement with the base 32. By self-releasing engagement is meant that the lifting connector 48 operates to automatically disconnect the from its connection with the second end of the base 32, once the handle 12 moves toward a raised position to raise the projecting member 54, such as in FIG. 1 from the lowered position as in FIG. 3. Currently, a particularly favored self-releasing lifting connecter 48, is formed by a magnet 50 positioned on one of the projecting member 54 or the base 32 and a magnetically attractive material 52 on the other of the base 32 or the projecting member 54, as depicted in FIG. 5.

While shown as the magnet 50 being on a spring loaded projecting member 54 connected to the compacting member 26, the magnet 50 could be positioned on the base 32 with the magnetically attractive material 52 being positioned in an engagement with a spring loaded projecting member 54. As shown in FIGS. 4-5, the projecting member 54 may be slidably engaged with a passage in the compacting member 26, such that it retracts during the compressive movement of the compacting member 26 toward the base 32, if contact is made therewith.

A biasing member 55 or component, such as a spring, will serve to continuously bias the projecting member 54 toward a position projecting from the compacting member 24, wherein the magnet 50 can contact against or be positioned adjacent the base 32, and exert a pulling force upon the magnetic attractive material 52, to exert force to thereby pull the base 32 to the angled position of FIG. 5.

The magnet 50 and magnetically attractive material 52, such as iron or nickel, are preferred as the self-releasing lifting connector 48, because in experimentation with multiple releasing connectors this combination worked well and was not overly affected by liquids or metal shards or the like from the can. Further, using such magnetic attraction, rather then a mechanical connection, the force to lift the base 32 is provided, but does not require an actual connection or contact therewith, which can jam or become otherwise contaminated over time by metal or liquids. However, for a lesser performing device, the releasing lift connector shown herein as 48, may also be formed of other self releasing connective components such as hook and loop fabric, gearing which releases, or other temporarily mating components which release once the base 32 has reached the angle A, to allow the can to slide, and the handle moves further upward.

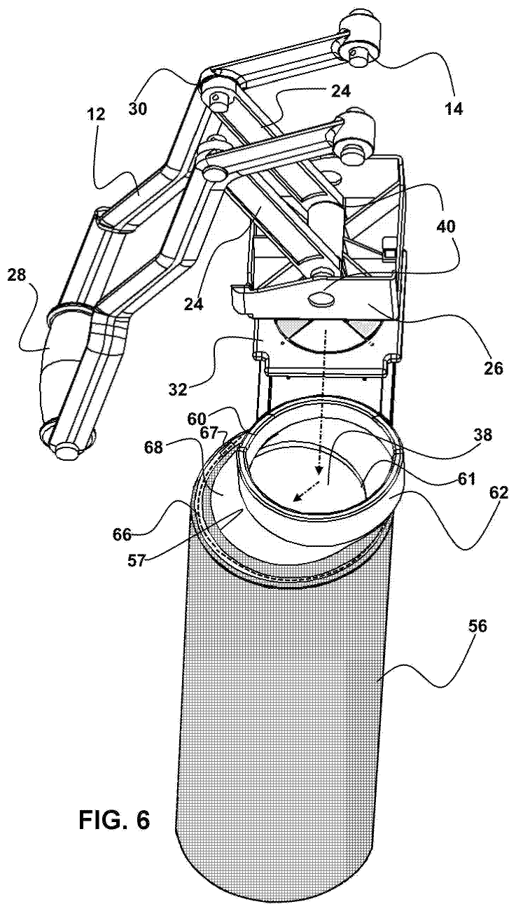

In FIG. 6 is shown the device 10 from an overhead view with the housing removed for clarity of depicting the internal components. As shown, the base 32 when tilted to the angle A, as in FIG. 5, will cause a compacted can 34 to lose frictional engagement with the surface of the base 32, and to slide through the second opening 36 and into the chute 38. The chute 38 communicates with an internal chamber of a flexible duffel or bag 56, and the crushed can 34 sliding from the base 32 which is inclined, will drop through the chute 38 and into the internal chamber of the bag 56. In experimentation, it was found that configuring the lifting connector 48, such as the magnet 50 and attractive material 52, to release from lifting the base 32, only after the angle A, reaches between 25 to 50 degrees, provided sliding force to the can 34, sufficient to slide into a first opening 60 communicating with the interior chamber 58 of the bag 56. Lesser angles tended to cause the can 34 to occasionally hang up upon the edge of the chute 38 at the first opening 60.

Additionally preferred is the formation of a chute 38 having a chute wall 62 which surrounds the first opening 60 of the chute 38, where the chute wall 62 has a lower or recessed portion 64 positioned on a side of the chute wall 62, which is adjacent and substantially aligned with the second opening 36. Such worked well on occasions where the handle 12 is lifted quickly from the second position, to activate the tilting of the base 32, which imparted additional force to eject the can 34 through the second opening 36. The recessed portion 64 of the chute wall 62 has a top edge located in a position lower than the connection 46 of the base 32 to the sidewall 44 as in FIG. 5. Thus, the recessed portion 64 defines a passage through the chute wall 62, through which the can 34 passes once the base 32 is elevated as in FIG. 5.

The chute wall 62 surrounding the chute 38, on the opposite side from the recessed portion 64, has a top edge which is located at a height equal to that of the rotating connection 46, and higher than the top edge of the recessed portion 64. This chute wall 62 thus forms a backstop for an ejected can 34 sliding from the base to contact, and then drop into the chute 38.

By having a top edge located equal to or higher is meant, that this top edge is at or above an imaginary line 35 (FIG. 1) forming a plane extending from and parallel to a top surface 33 of the base 32. Thus the top edge of the chute wall 62 opposite the recessed portion 64 will align with or be positioned above the plane defined by the imaginary line 35, and the top edge of the recessed portion 64 of the chute wall would be positioned below the plane defined in imaginary line 35.

While the device will function with just the chute 38 and without the chute wall 62 and recessed portion 64, the device herein was found to work better to catch and deposit cans 34 into the chute 38, with the inclusion of the chute wall 62. The chute wall 62 acted to contact and redirect cans 34 passing through the recessed portion 64 thereof, into the chute 38, and thereby prevented cans 34 from missing entry into the chute 38.

Also shown in FIG. 6, is a preferred mode of the device 10 wherein the chute 38 has a curved passage therein, extending between the first opening 60, and a second opening 61, which is misaligned with the first opening 60, and which communicates with the chamber 58 within an attached bag 56. This curved or nonlinear passage thereby formed between the first opening 60 and second opening 61, allowed the cans 34 to fall into the chamber 58 with less force and noise and the misalignment forms a sound dampener by slowing the can 34 during communication through the nonlinear passage and thereby allowing for a slower drop or descending of the crushed can into the bag 56.

The bag 56 shown in FIG. 6, may be supplied by the user. However, the device 10 herein, in order to reduce the significant number of plastic bags being disposed with cans, preferably includes a bag 56 which is formed of a home washable, home recyclable monofilament or other mesh material which allows for the communication of air and liquids therethrough. By employing such a mesh material, the formation of mold and other pathogens is significantly reduced or eliminated from that which develops in plastic bags and reduces the number of such plastic bags which are difficult to separate from cans. This allows the filled bag 56 of crushed cans 34, to be removed and temporarily stored for later delivery to a recycle center. Thereafter the same bag 56 or a replacement mesh bag 56 may be installed to continue processing.

As an example and in no way limiting, the mesh or breathable fabric may be knitted or woven or non-woven polymeric monofilament, or a polymeric coated mesh scrim, such as for example PHIFERTEX from Phifer Mills.

Where the breathable bag 56 is included with the device 10, a closure or bag connector 66 such as a drawstring, tie, cord, or other flexible member with a releasable cord lock 67, or another releasable bag connector 66, will be positioned in an engagement with the wall of the bag 56 at a position surrounding the open end 57 of the bag 56, through which the cans 34 communicate to the interior chamber 58 of the bag 56. The releasable bag connector 66 for example can be positioned within a pocket or hem, formed around the open end 57 of the bag 56, and cinched to hold the bag 56 on the ledge 68. In this fashion the open end 57 of the bag 56 can be removably engaged to a ledge 68 surrounding the chute 38, using the bag connector 56, during the collection of ejected compacted cans. Once sufficiently full, the bag 56 may be removed by releasing the cord lock 67, and emptied, and then re-engaged to the ledge 68 or another connection area surrounding the chute 38.

As noted, any of the different configurations and components can be employed with any other configuration or component shown and described as part of the can crushing device herein. Additionally, while the disclosed can crushing invention has been described herein with reference to particular embodiments thereof and components engaged for operation, a latitude of modifications, various changes and substitutions are intended in the foregoing disclosures and it will be appreciated that in some instance some features, or configurations, or operations of the invention could be employed without a corresponding use of other features without departing from the scope of the invention as set forth in the following claims. All such changes, alternations and modifications as would occur to those skilled in the art, are considered to be within the scope of this invention as broadly defined in the appended claims.

Further, the purpose of any abstract of this specification is to enable the U.S. Patent and Trademark Office, the public generally, and especially the scientists, engineers, and practitioners in the art who are not familiar with patent or legal terms or phraseology, to determine quickly from a cursory inspection the nature and essence of the technical disclosure of the application. Any such abstract is neither intended to define the invention of the application, which is measured by the claims, nor is it intended to be limiting, as to the scope of the invention in any way.

What is claimed is:

1. A can crushing apparatus, comprising:
a housing;
a handle having a first end and having a second end;
said second end of said handle in a pivoting engagement with said housing;
said handle pivotable between an elevated position and a lowered position;
a connecting member having a first end in a rotational engagement to said handle;
said connecting member having a second end engaged with a compacting member;
said housing having an internal cavity positioned in between said compacting member and a base;
a first opening in said housing communicating with said internal cavity, said first opening configured for insertion of a can into said internal cavity therethrough;
said base having a first side opposite a second side thereof;
a rotating connection of said base to said housing;
said base pivotable at said rotating connection to move between a substantially level position and a tilted position;
said second side of said base being elevated above said first side of said base, with said base in said tilted position;
a lifting connector, said lifting connector in an operative engagement with said handle, said lifting connector actuated in a first movement, to move from a first position to a second position, by a movement of said handle from said raised position toward said lowered position;
said lifting connector forming a removable engagement with said base while located in said second position;
said lifting connector being actuated in a second movement, from said second position toward said first position, by a movement of said handle from said lowered position toward said raised position; and
said second movement of said lifting connector, while in said removable engagement, moving to said base to said tilted position with said second side of said base elevated above said first side of said base, whereby a can positioned on said base will slide from said base when said base moves toward said tilted position.

2. A can crushing apparatus, additionally comprising:
said operative engagement of said lifting connector to said handle is formed by a projecting member engaged on a first end portion, with said compacting member; and
said projecting member extending to a second end;
a first releasable fastener positioned upon said second end of said projecting member; and
a second releasable fastener positioned on said base, said second releasable fastener being removably engageable with said first releasable fastener.

3. The can crushing apparatus of claim 1, additionally comprising:
a second opening formed into said housing;
said second opening being substantially aligned with said first end of said base; and
said second opening forming a passage for said can sliding from said base, to exit said housing.

4. The can crushing apparatus of claim 2, additionally comprising:
a second opening formed into said housing;
said second opening being substantially aligned with said first end of said base; and
said second opening forming a passage for said can sliding from said base, to exit said housing.

5. The can crushing apparatus of claim 3, additionally comprising:
a chute connected to said housing, said chute having a first opening therein sized for passage therethrough of said can exiting from said second opening;
said chute removably engageable with an open end of a bag, whereby said can exiting said second opening and passing through said chute, is deposited in said bag.

6. The can crushing apparatus of claim 4, additionally comprising:
a chute connected to said housing, said chute having a first opening therein sized for passage therethrough of said can exiting from said second opening;
said chute removably engageable with an open end of a bag, whereby said can exiting said second opening and passing through said chute, is deposited in said bag.

7. The can crushing apparatus of claim 5, wherein said chute is removably engageable with a bag, upon a ledge in engagement with said chute, said ledge surrounding said chute and projecting therefrom.

8. The can crushing apparatus of claim 6, wherein said chute is removably engageable with a bag, upon a ledge in engagement with said chute, said ledge surrounding said chute and projecting therefrom.

9. The can crushing apparatus of claim 2, wherein said removable engagement of said lifting connector with said base comprises:
a magnet positioned on one of said second end of said projecting member or said base; and
magnetically attractive material positioned on the other of said second end of said projecting member or said base.

10. The can crushing apparatus of claim 4, wherein said removable engagement of said lifting connector with said base comprises:
a magnet positioned on one of said second end of said projecting member or said base; and
magnetically attractive material positioned on the other of said second end of said projecting member or said base.

11. The can crushing apparatus of claim 6, wherein said removable engagement of said lifting connector with said base comprises:
a magnet positioned on one of said second end of said projecting member or said base; and
magnetically attractive material positioned on the other of said second end of said projecting member or said base.

12. The can crushing apparatus of claim 8, wherein said removable engagement of said lifting connector with said base comprises:
a magnet positioned on one of said second end of said projecting member or said base; and
magnetically attractive material positioned on the other of said second end of said projecting member or said base.

13. The can crushing apparatus of claim 1 additionally comprising:
a cover engaged upon said handle;
said cover forming a shield between a user actuating said handle and said first opening to said internal cavity; and
wherein said shield blocks debris exiting said internal cavity from striking said user and concurrently prevents said user from inserting a finger into said internal cavity, and during said movement of said handle from said raised position toward said lowered position.

14. The can crushing apparatus of claim 12 additionally comprising:
a cover engaged upon said handle;
said cover forming a shield between a user actuating said handle and said first opening to said internal cavity; and
wherein said shield blocks debris exiting said internal cavity from striking said user and concurrently prevents said user from inserting a finger into said internal cavity, and during said movement of said handle from said raised position toward said lowered position.

15. The can crushing apparatus of claim 5 additionally comprising:
said chute having a nonlinear passage extending between said first opening and a second opening of said chute; and
said non linear passage defining a sound dampener for said can exiting from said second opening during passage therethrough and into said bag.

16. The can crushing apparatus of claim 6 additionally comprising:
said chute having a nonlinear passage extending between said first opening and a second opening of said chute; and
said non linear passage defining a sound dampener for said can exiting from said second opening during passage therethrough and into said bag.

17. The can crushing apparatus of claim 12 additionally comprising:
said chute having a nonlinear passage extending between said first opening and a second opening of said chute; and
said non linear passage defining a sound dampener for said can exiting from said second opening during passage therethrough and into said bag.
